(19) United States
(12) Patent Application Publication
(10) Pub. No.: US 2026/0179395 A1
(43) Pub. Date: Jun. 25, 2026

(54) INFORMATION PROCESSING APPARATUS AND INFORMATION PROCESSING METHOD

(71) Applicant: Hitachi, Ltd., Tokyo (JP)

(72) Inventors: Yosuke ISOMURA, Tokyo (JP); Yuki YOKOYAMA, Tokyo (JP)

(21) Appl. No.: 19/303,858

(22) Filed: Aug. 19, 2025

(30) Foreign Application Priority Data
Dec. 25, 2024 (JP) 2024-228633

(51) Int. Cl. G06V 20/59; G07C 5/02

(52) U.S. Cl. CPC G06V 20/597; G07C 5/02

(57) ABSTRACT

The burden of an administrator to confirm a driver's compliance state with safe driving is reduced while the communication volume of videos from an in-vehicle terminal is limited to a minimum. An information processor determines the presence or absence of safe driving behavior of a driver on the basis of video data received from a vehicle and/or a terminal on the vehicle. The processor receives mobile body information including information about the speed and location of the vehicle; and detects an event related to the movement of the vehicle from the mobile body information. The video data that is received includes driving operations of the driver corresponding to an event related to movement of the vehicle. The processor identifies a condition corresponding to the event; and obtains a determination result by using the condition and the video data as inputs to a determination unit.

### CROSS-REFERENCE TO RELATED APPLICATION

The present application claims priority from Japanese application JP2024-228633, filed on December 25, 2024, the content of which is hereby incorporated by reference into this application.

### BACKGROUND OF THE INVENTION

### 1. Field of the Invention

The present invention relates to an information processing apparatus and an information processing method.

### 2. Description of the Related Art

Existing in the art is a technology for acquiring videos related to dangerous driving. In PTL 1, “to provide a drive recorder that enables acquisition of a desired image captured when an impact with a strength meeting a predetermined condition has been measured.” and “in a drive recorder 1, a travel recording module 51 records captured moving-imagery data 60 captured by a camera 18 installed on a vehicle. An acceleration sensor 19 measures the acceleration of the vehicle. When it is determined that an acceleration measured by the acceleration sensor 19 is within an abnormality range, the drive recorder 1 at a predetermined timing notifies a server 4 of the time point of dangerous driving at which the acceleration within the abnormality range is measured. A video transmission unit, when receiving from the server 4 a request for video transmission containing the time point of dangerous driving, transmits to the server, out of the recorded captured moving-imagery data 60, captured moving-imagery data 60 associated with a predetermined time period including the time point of dangerous driving contained in the request for video transmission.” are described.

### Patent Literature

PTL 1 Japanese Patent Application Publication No. 2016-207006

### SUMMARY OF THE INVENTION

Ensuring safety is extremely important in the logistics industry. As a method to ensure safety, a method in which an administrator reviews a driver's driving video can be considered. However, confirming all of a driver’s normal driving requires communication to send all video data from an in-vehicle terminal to a server for the administrator to review, which leads to a problem of a significant increase in communication volume, and there is also a problem that it is impossible to secure enough time for the administrator to review all the videos. As a method to reduce communication volume, as described in PTL 1, there is a method in which only videos for the time periods detected by sensors of an in-vehicle terminal are linked to a server, allowing an administrator to view only the videos for target time periods. However, this method is limited only to videos of cases where abnormal driving detectable by sensors occurs, so it is impossible to confirm from the videos whether the driver is performing safety measures such as pointing and calling or visual confirmation to prevent accidents in advance. Thus, there remains an issue in terms of ensuring safety.

As a solution to the challenge of securing the administrator’s time, in recent years, technological development using generative artificial intelligence (AI) has been advancing in the field of video analysis, and there are measures that utilize determinations made by generative AI. However, since generative AI cannot make determinations with a high accuracy rate unless specific queries are posed thereto, it is necessary to ask concrete questions, which may include questions that are originally unnecessary at the timing of the video, thereby imposing a high processing workload on generative AI, which is a problem. An example of an unnecessary question would be asking about the status of a non-existent traffic light in a video of a vehicle traveling straight on a highway.

An object of the present invention is to confirm that usual safety measures are being implemented, limit communication of videos from in-vehicle terminals, reduce the workload on servers performing generative AI-based determination processing, and also reduce the confirmation burden on an administrator.

In order to achieve the above object, one of representative information processing apparatuses of the present invention is an information processing apparatus for determining the presence or absence of safe driving behavior of a driver on the basis of video data, the information processing apparatus including: a communication portion that communicates with a vehicle and/or a terminal on the vehicle; and a processing portion that processes data, wherein the communication portion receives mobile body information including information about the speed and location of the vehicle; the processing portion detects an event related to the movement of the vehicle from the mobile body information; the communication portion receives video data including driving operations of the driver corresponding to the event; the processing portion identifies a condition corresponding to the event; and the processing portion obtains a determination result by using the condition and the video data as inputs to a determination portion.

In addition, one of representative information processing methods of the present invention is an information processing method for determining the presence or absence of safe driving behavior of a driver on the basis of video data, the information processing method including the steps of: an information processing apparatus receiving, from a vehicle and/or a terminal on the vehicle, mobile body information including information about the speed and location of the vehicle; the information processing apparatus detecting an event related to the movement of the vehicle from the mobile body information; the information processing apparatus receiving video data including driving operations of a driver corresponding to the event; the information processing apparatus identifying a condition corresponding to the event; and the information processing apparatus obtaining a determination result by using the condition and the video data as inputs to a determination portion.

According to the present invention, it is possible to reduce the burden on an administrator to confirm a driver's compliance state with safe driving while limiting the communication volume of videos from an in-vehicle terminal to the bare minimum. Problems, configurations, and effects other than those described above will be clarified by the following description of the embodiments.

### BRIEF DESCRIPTION OF THE DRAWINGS

FIG. 1 is a diagram showing a hardware configuration of a system;

FIG. 2 is a flowchart of processing executed by an information processing apparatus in the system;

FIG. 3A is a flowchart showing details of measurement information processing;

FIG. 3B is a flowchart showing details of measurement information processing;

FIG. 4 is a specific example of a determination table;

FIG. 5 is a flowchart of a video request;

FIG. 6 is a flowchart of determination processing;

FIG. 7 is a flowchart of real-time notification;

FIG. 8 is a specific example of a management screen (first example);

FIG. 9 is a specific example of a management screen (second example);

FIG. 10 is a specific example of a management screen (third example);

FIG. 11 is a specific example of event result information; and

FIG. 12 is a specific example of a determination result table.

### DESCRIPTION OF THE PREFERRED EMBODIMENTS

Hereinafter, embodiments of the present invention will be described with reference to the drawings. Embodiments are for describing the present invention, and are omitted and simplified as appropriate for clarity of description. The present invention can be implemented in various other forms. Unless otherwise specified, each component may be singular or plural.

Positions, sizes, shapes, ranges, and the like of the components illustrated in the drawings may not represent actual positions, sizes, shapes, ranges, and the like in order to facilitate understanding of the invention. Therefore, the present invention is not necessarily limited to the positions, sizes, shapes, ranges, and the like illustrated in the drawings.

Examples of various types of information may be described in terms of expressions such as “table”, “list”, and “queue”, but various types of information may be expressed in a data structure other than the above expressions. For example, various types of information such as “XX table”, “XX list”, and “XX queue” may be “XX information”. In describing identification information, expressions such as “identification information”, “identifier”, “name”, “ID”, and “number” are used, but the expressions can be replaced with each other.

In a case where there is a plurality of components having the same or similar functions, the same reference signs may be denoted with different subscripts for description. In addition, in a case where it is not necessary to distinguish the plurality of components, the description may be made by omitting the subscript.

In the embodiments, processing performed by executing a program may be described. Here, the computer executes a program by a processor (for example, a CPU and a GPU), and performs processing defined by the program using a storage resource (for example, a memory), an interface device (for example, a communication port), and the like. Therefore, the subject of the processing performed by executing the program may be a processor. Similarly, the subject of the processing performed by executing the program may be a controller, an apparatus, a system, a computer, or a node having a processor. The subject of the processing performed by executing the program may be an arithmetic portion, and may include a dedicated circuit that performs specific processing. Here, the dedicated circuit is, for example, a field programmable gate array (FPGA), an application specific integrated circuit (ASIC), a complex programmable logic device (CPLD), or the like.

The program may be installed on the computer from a program source. The program source may be, for example, a program distribution server or a computer-readable storage medium. In a case where the program source is a program distribution server, the program distribution server may include a processor and a storage resource that stores a distribution target program, and the processor of the program distribution server may distribute the distribution target program to another computer. In the embodiments, two or more programs may be implemented as one program, or one program may be implemented as two or more programs.

### First Embodiment

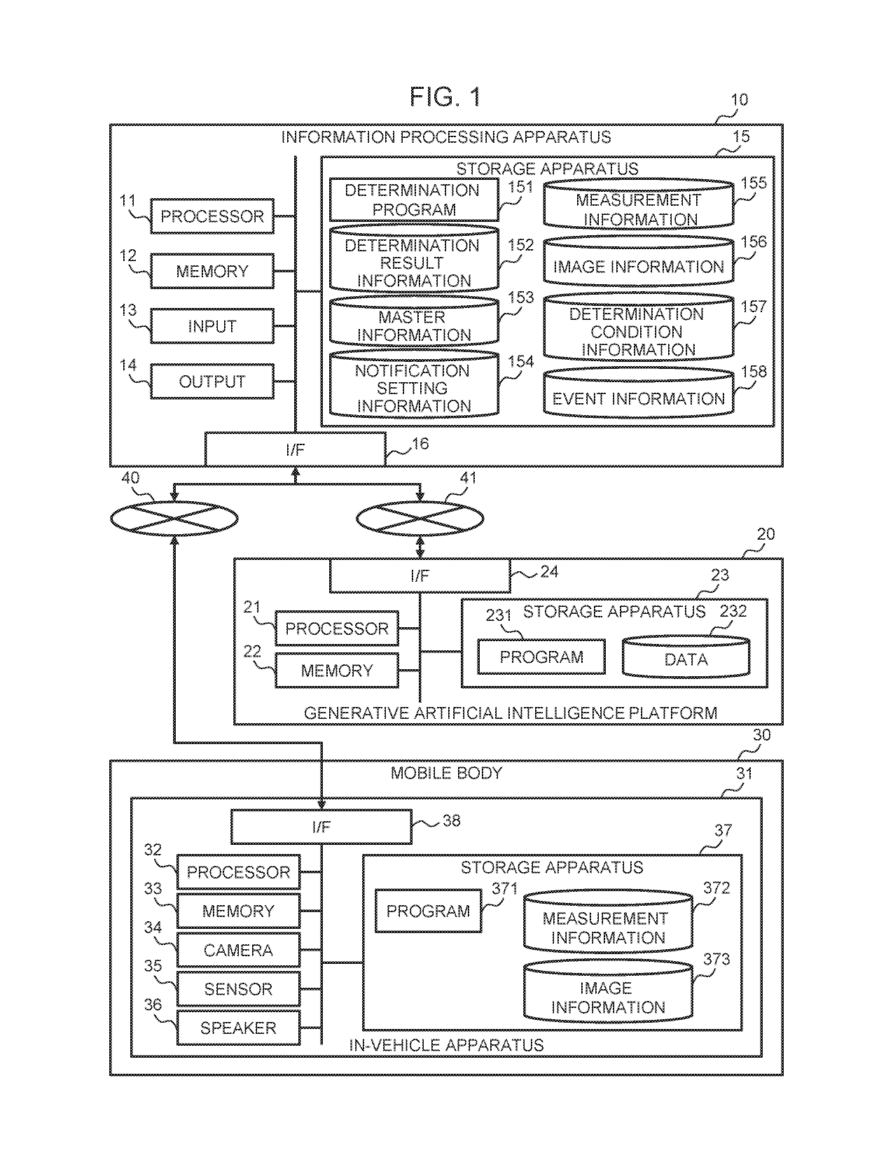

FIG. 1 is a diagram showing a hardware configuration of this system. This system includes an information processing apparatus 10, a generative artificial intelligence platform 20, and a mobile body 30. The information processing apparatus 10, the generative artificial intelligence platform 20, and the mobile body 30 are coupled to each other over a network. The information processing apparatus 10 includes, for example, a processor 11, a memory 12, an input apparatus 13, an output apparatus 14, a storage apparatus 15, and an interface apparatus 16. The processor 11 operates as a “processing portion”, the memory 12 and the storage apparatus 15 operate as “storage portions”, the input apparatus 13 operates as an “input portion”, the output apparatus 14 operates as an “output portion”, and the interface apparatus 16 operates as an “interface portion”.

The hardware configuration of the information processing apparatus 10 may be composed of one or a plurality of computers (electronic computers). The information processing apparatus 10 may also be referred to as an information processing system. Each component of the hardware of the information processing apparatus 10 may be singular or plural. The information processing apparatus 10 may be one or more physical computers having hardware such as the processor 11, the memory 12, the input apparatus 13, the output apparatus 14, the storage apparatus 15, and the interface apparatus 16, or a system (for example, a cloud computing system) implemented on one or more physical computers (for example, a cloud platform). In addition, each apparatus included in the information processing apparatus 10 may be configured in one physical computer or may be configured in a plurality of physical computers in a distributed manner. Each program and each piece of information stored in the storage apparatus 15 may be stored in one storage apparatus or may be stored in a plurality of storage apparatuses in a distributed manner.

The processor 11 is a device responsible for the overall operation control of the information processing apparatus 10. The processor 11 may be an arithmetic apparatus or a control apparatus, and may be composed of a processor such as a central processing unit (CPU) or a graphics processing unit (GPU), or may include a dedicated circuit that performs specific processing. Here, the dedicated circuit is, for example, a field programmable gate array (FPGA), an application specific integrated circuit (ASIC), a complex programmable logic device (CPLD), or the like.

The memory 12 is used as a work memory for the processor 11. In the storage apparatus 15, programs and various types of information are stored. In the present embodiment, in the storage apparatus 15, for example, a program 151, determination result information 152, master information 153, notification setting information 154, measurement information 155, image information 156, determination condition information 157 and event information 158 are stored.

The input apparatus 13 is composed of, for example, a mouse, a keyboard, etc., and is used to input to the information processing apparatus 10 information and instructions required by an operator. The output apparatus 14 may be, for example, a display apparatus such as a liquid crystal display or an organic electro luminescence (EL) display.

The interface apparatus 16 is an apparatus that operates as a communication portion for performing communication with an external apparatus by means of a predetermined communication method, and may be composed of, for example, a wireless LAN card. The information processing apparatus 10 can perform communication with the generative artificial intelligence platform 20 via a network 41 by means of the interface apparatus 16. In addition, the information processing apparatus 10 can perform communication with the mobile body 30 via a network 40 by means of the interface apparatus 16.

The network 40 may be any wireless communication network. The network 41 may be any wired communication network or any wireless communication network. As the wireless communication network, a 5th-generation mobile communication system, so-called 5th Generation (5G) that enables “multiple concurrent connections” and “ultra-low latency”, can be used. Further, by taking advantage of features of a new mobile telephone system in or after 5G, improvement in the effects of the present invention can also be expected.

The generative artificial intelligence platform 20 is, for example, a generative AI including a processor 21, a memory 22, a storage apparatus 23, and an interface apparatus 24. The processor 21 operates as a “processing portion”, the memory 22 and the storage apparatus 23 operate as “storage portions”, and the interface apparatus 24 operates as an “interface portion”. The generative artificial intelligence platform 20 is connected to the information processing apparatus 10 via the network 41, but it may also run on the same apparatus as the information processing apparatus 10 and share a processor, memory, and storage apparatus. The generative artificial intelligence platform is a platform that can use past learned data to provide answers assumed to be optimal for received instructions. In the present embodiment, the generative artificial intelligence platform 20 receives a condition and video data as inputs and determines the presence or absence of safe driving behavior of a driver. For example, the generative artificial intelligence platform 20 receives video data showing the period before and after the vehicle speed rises from 0 m/s, along with the condition of “whether pointing and calling is performed”. When determining that the driver is performing pointing and calling in the video data, the generative artificial intelligence platform 20 outputs “safe driving”. When determining that the driver is not performing pointing and calling in the video data, the generative artificial intelligence platform 20 outputs “unsafe driving”.

The mobile body 30 shall include an in-vehicle apparatus 31. The in-vehicle apparatus 31 may not only be an in-vehicle terminal mounted on a vehicle, such as a drive recorder or a digital tachograph, but also an apparatus (a portable terminal that can be installed in a vehicle) that moves along with the mobile body, such as a smartphone or a smart device. The in-vehicle apparatus 31 includes, for example, a processor 32, a memory 33, a camera 34, a sensor 35, a speaker 36, a storage apparatus 37, and an interface apparatus 38. The processor 32 operates as a “processing portion”, the memory 33 and the storage apparatus 37 operate as “storage portions”, and the interface apparatus 38 operates as an “interface portion”. The sensor is a sensor attached to the in-vehicle apparatus, such as a GPS sensor, a gyro sensor, an acceleration sensor, or a gravitational acceleration sensor. In addition, the mobile body 30 may be configured to transmit the output of a sensor provided in a vehicle body to the information processing apparatus 10.

The in-vehicle apparatus 31 saves, in image information 373 in the storage apparatus 37, videos or images captured by the camera 34, and saves, in measurement information 372, sensor data collected by the sensor 35. The collected sensor data is transmitted to the information processing apparatus 10 via the network 40 by means of the interface apparatus 38, and is also saved in the measurement information 155 of the storage apparatus 15.

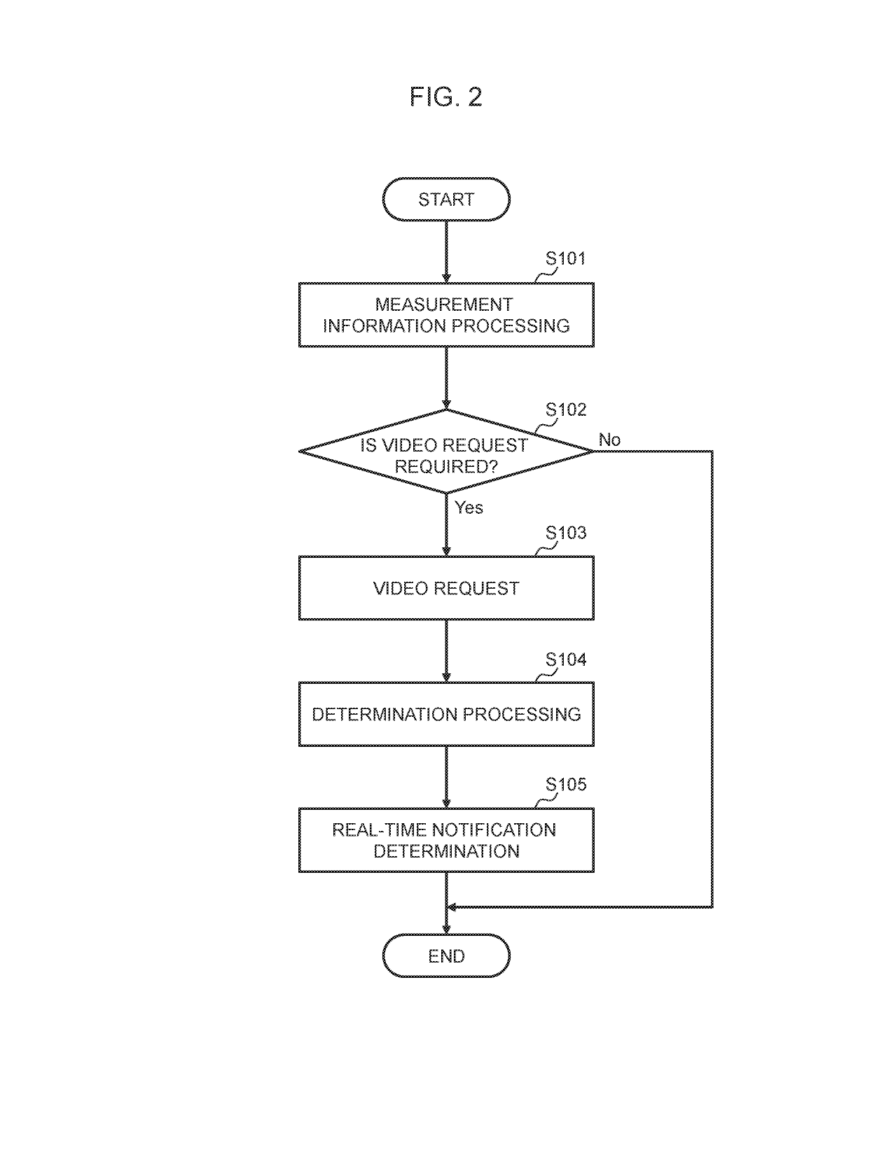

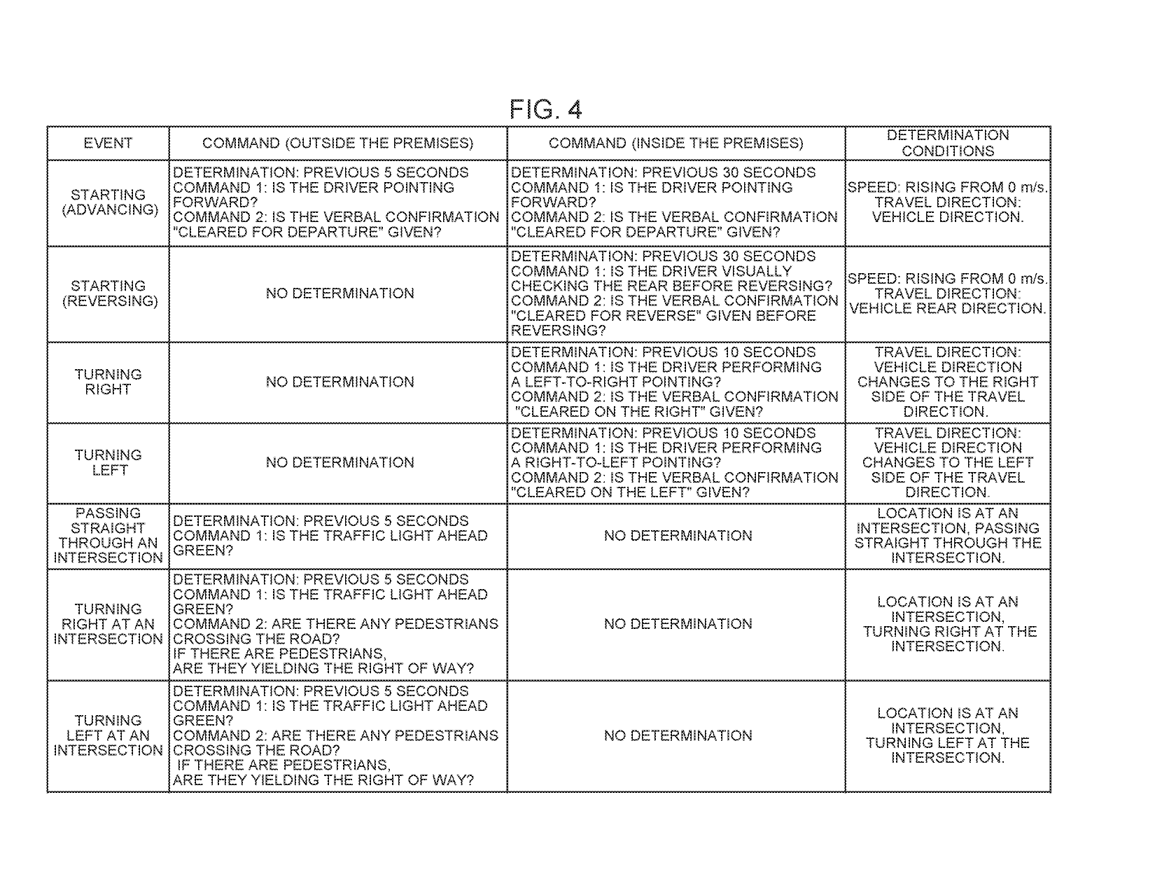

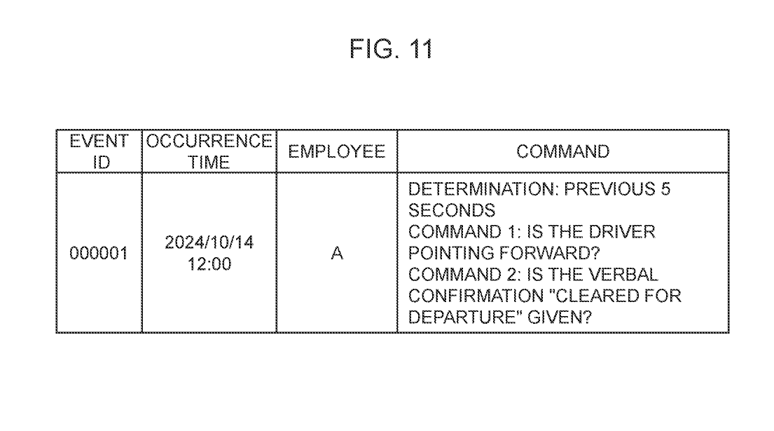

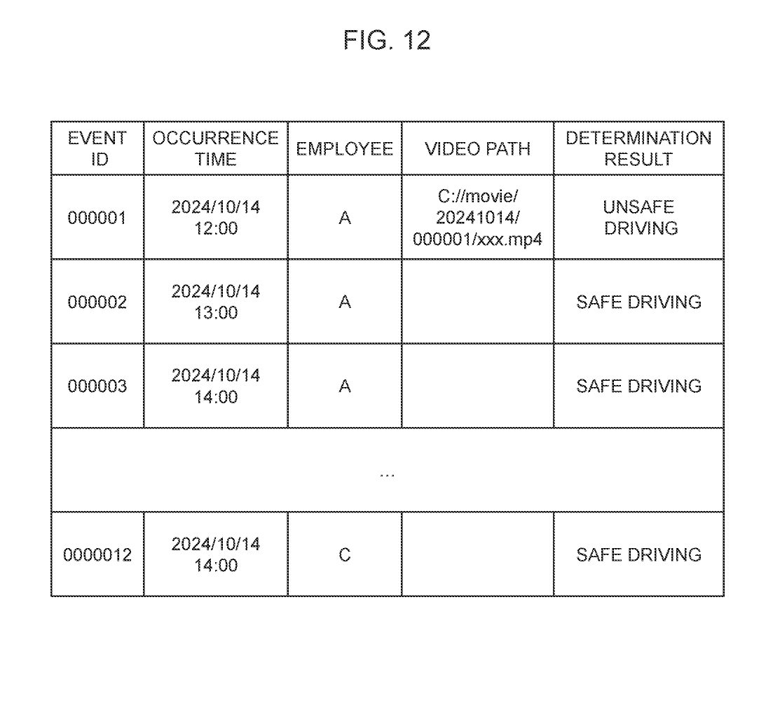

FIG. 2 is a flowchart of processing executed by the information processing apparatus in this system, which is executed periodically to process measurement information collected from the mobile body. In step S101, the collected measurement information is processed, and it is determined whether it is consistent with the determination conditions in the determination table of FIG. 4. If consistent, an event ID is issued, and the occurrence time, the employee information, and the command in the determination table of FIG. 4 are made into an event result information table as shown in FIG. 11 and saved in the event information 158 in FIG. 1. In step S102, in the case where there is data saved in the table in step S101, it is determined that a video is required, and the processing proceeds to step S103. In step S103, the video for a time period specified in the determination of the command is acquired from the mobile body on the basis of the occurrence time saved in the table. For example, if the determination of the command states “the previous 30 seconds”, the video from 30 seconds before the occurrence time up to the occurrence time is acquired. In step S104, the video acquired in step S103 and the command text acquired in step S101 are provided to the generative artificial intelligence platform to acquire a determination result. If the determination result is NO, it is regarded as unsafe driving, and the occurrence time, the employee information, and the file path of the video provided to the artificial intelligence are combined and saved in the determination result information 152 shown in FIG. 1 as the determination result table shown in FIG. 12. If the determination result is YES, it is regarded as safe driving, and the occurrence time and the employee information are combined and saved in the determination result information 152 shown in FIG. 1 as the determination result table shown in FIG. 12.

In step S105, a notification is sent to the mobile body on the basis of the determination result acquired in step S104.

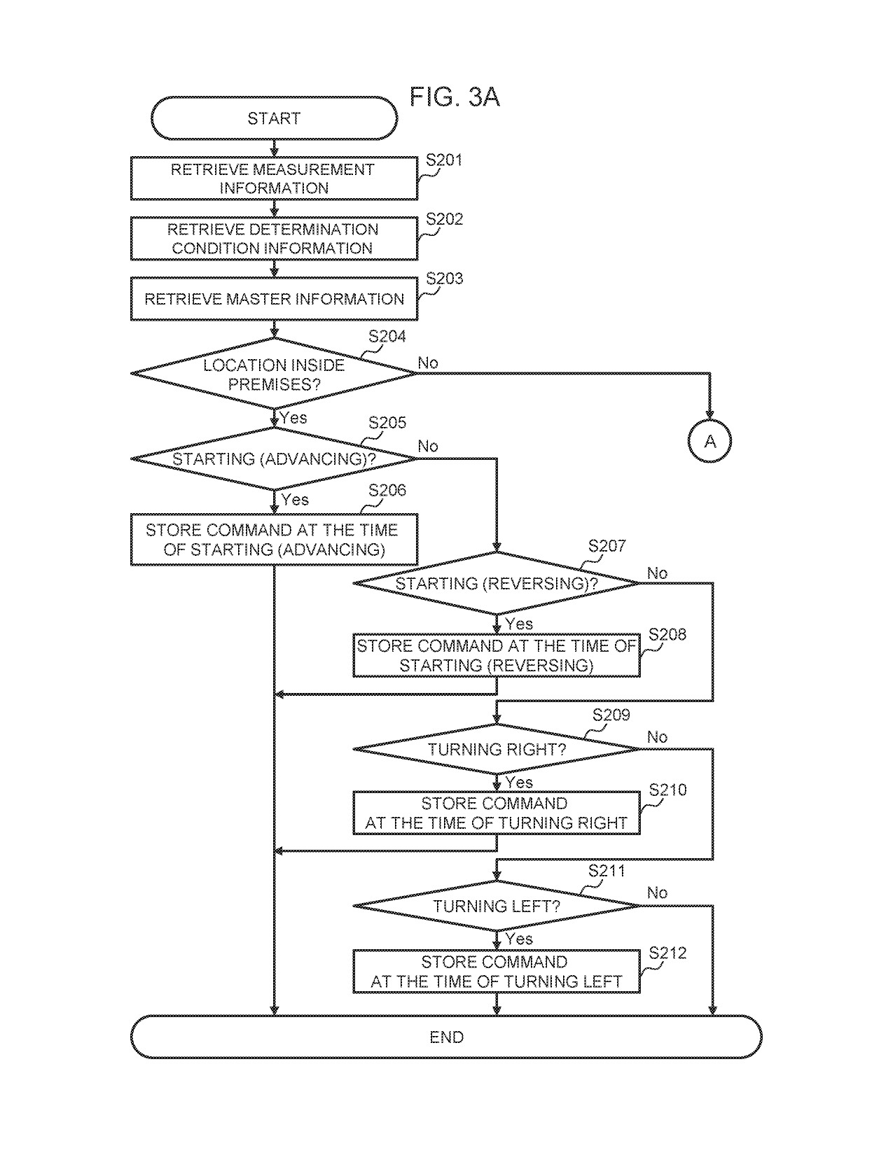

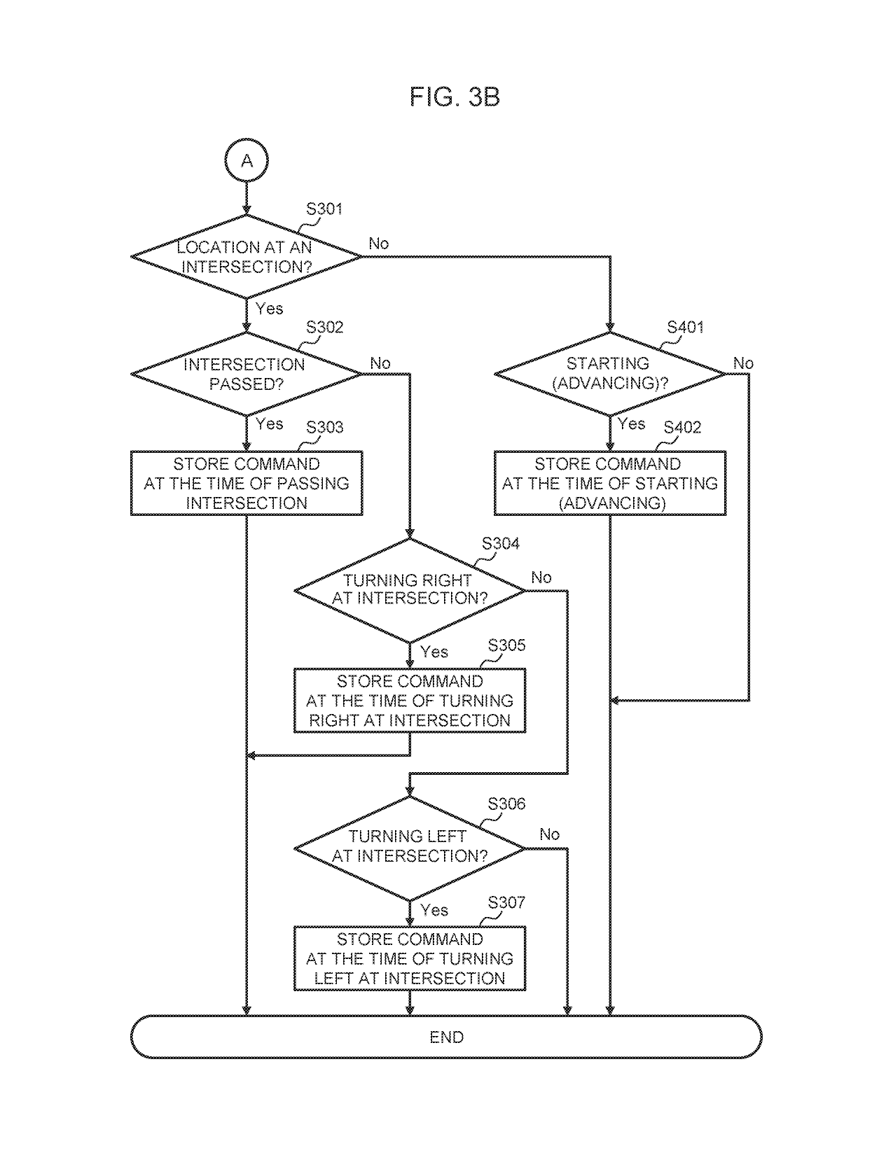

FIG. 3A,3B is a more detailed explanation of step S101 in FIG. 2. In step S201, measurement information is acquired from the measurement information 155 in FIG. 1. Next, in step S202, determination condition information is acquired from the determination condition information 157 in FIG. 1. The determination condition information is the determination table in FIG. 4. Next, in step S203, master information is acquired from the master information 153 in FIG. 1. The master information includes intersection information, location information of a facility, and the like. In step S204, the location information of a facility is compared with the location information of the mobile body included in the measurement information, and it is determined whether the location of the mobile body is inside the premises of a facility. If the location of the mobile body is inside the premises, the processing proceeds to step S205; if the location is not inside the premises, the processing proceeds to step S301. In step S205, the starting (advancing) determination condition acquired from the determination information is combined with the location information of the mobile body included in the measurement information, and it is confirmed whether the condition is satisfied. Regarding speed determination, it is common to use speed information from a GPS sensor, but it may alternatively be calculated using an acceleration sensor or on the basis of location information. The traveling direction is generally determined on the basis of the value of an acceleration sensor when the in-vehicle apparatus is fixed to the mobile body, but alternative methods such as combining location information with a reversing signal of the vehicle may also be used. (In the following descriptions of determination conditions, traveling reports and speeds can be obtained in a similar manner, so the description thereof will be omitted.) If the condition is satisfied, the processing proceeds to step S206; if the condition is not satisfied, the processing proceeds to step S207. In step S206, an event ID is issued, the occurrence time, the employee information, and the content of command (inside the premises) related to starting (advancing) in the determination table of FIG. 4 are made into an event result information table as shown in FIG. 11 and saved in the event information 158 in FIG. 1, and then the processing is ended. In step S207, the starting (reversing) determination condition acquired from the determination information is combined with the location information of the mobile body included in the measurement information, and it is confirmed whether the condition is satisfied. If the condition is satisfied, the processing proceeds to step S208; if the condition is not satisfied, the processing proceeds to step S209. In step S208, an event ID is issued, the occurrence time, the employee information, and the content of command (inside the premises) related to starting (reversing) in the determination table of FIG. 4 are made into an event result information table as shown in FIG. 11 and saved in the event information 158 in FIG. 1, and then the processing is ended. In step S209, the turning-right determination condition acquired from the determination information is combined with the location information of the mobile body included in the measurement information, and it is confirmed whether the condition is satisfied. If the condition is satisfied, the processing proceeds to step S210; if the condition is not satisfied, the processing proceeds to step S211. In step S210, an event ID is issued, the occurrence time, the employee information, and the content of command (inside the premises) related to turning right in the determination table of FIG. 4 are made into an event result information table as shown in FIG. 11 and stored in the event information 158 in FIG. 1, and the processing is ended. In step S211, the turning-left determination condition acquired from the determination information is combined with the location information of the mobile body included in the measurement information, and it is confirmed whether the condition is satisfied. If the condition is satisfied, the processing proceeds to step S212; if the condition is not satisfied, the processing is ended. In step S212, an event ID is issued, the occurrence time, the employee information, and the content of command (inside the premises) related to turning left in the determination table of FIG. 4 are made into an event result information table as shown in FIG. 11 and saved in the event information 158 in FIG. 1, and then the processing is ended. In step S301, the intersection information is compared with the location information of the mobile body included in the measurement information, and it is determined whether the location of the mobile body is at an intersection. If the location is at an intersection, the processing proceeds to step S302; if the location is not at an intersection, the processing proceeds to step S401. In step S302, the passing-straight-through-an-intersection determination condition acquired from the determination information is combined with the location information of the mobile body included in the measurement information, and it is confirmed whether the condition is satisfied. If the condition is satisfied, the processing proceeds to step S303; if the condition is not satisfied, the processing proceeds to step S304. In step S303, an event ID is issued, the occurrence time, the employee information, and the content of command (outside the premises) related to passing straight through an intersection in the determination table of FIG. 4 are made into an event result information table as shown in FIG. 11 and saved in the event information 158 in FIG. 1, and then the processing is ended. In step S304, the turning-right-at-an-intersection determination condition acquired from the determination information is combined with the location information of the mobile body included in the measurement information, and it is confirmed whether the condition is satisfied. If the condition is satisfied, the processing proceeds to step S305; if the condition is not satisfied, the processing proceeds to step S306. In step S305, an event ID is issued, the occurrence time, the employee information, and the content of command (outside the premises) related to turning right at an intersection in the determination table of FIG. 4 are made into an event result information table as shown in FIG. 11 and saved in the event information 158 in FIG. 1, and then the processing is ended. In step S306, the turning-left-at-an-intersection determination condition acquired from the determination information is combined with the location information of the mobile body included in the measurement information, and it is confirmed whether the condition is satisfied. If the condition is satisfied, the processing proceeds to step S307; if the condition is not satisfied, the processing is ended. In step S307, an event ID is issued, the occurrence time, the employee information, and the content of command (outside the premises) related to turning left at an intersection in the determination table of FIG. 4 are made into an event result information table as shown in FIG. 11 and saved in the event information 158 in FIG. 1, and then the processing is ended. In step S401, the outside-the-premises starting (advancing) determination condition acquired from the determination information is combined with the location information of the mobile body included in the measurement information, and it is confirmed whether the condition is satisfied. If the condition is satisfied, the processing proceeds to step S402; if the condition is not satisfied, the processing is ended. In step S402, an event ID is issued, the occurrence time, the employee information, and the content of command (outside the premises) related to starting (advancing) in the determination table of FIG. 4 are made into an event result information table as shown in FIG. 11 and saved in the event information 158 in FIG. 1, and then the processing is ended. It should be noted that the processing in FIG. 3 is configured according to the determination table in FIG. 4, but the method for determining safe driving in FIG. 4 varies from company to company, and the processing method needs to be adapted accordingly for each company.

In FIG. 4, the following events are illustrated as examples: starting (advancing), starting (reversing), turning right, turning left, passing straight through an intersection, turning right at an intersection, and turning left at an intersection. The determination condition in FIG. 4 is a condition for detecting the occurrence of an event. In the determination conditions of events, information about the speed (such as acceleration) and location information are used. For example, the event of starting can be detected with the speed rising from 0 m/s as the determination condition. In addition, the event of turning right at an intersection can be detected with the location information indicating that the location is at an intersection and vehicle having made a right turn as the determination condition.

The commands in FIG. 4 indicate the time range of the video data to be clipped corresponding to an event, as well as the confirmation operation that should be determined corresponding to the event. The commands are divided into two categories: inside the premises and outside the premises. “Inside the premises” refers to, for example, areas within the premises such as factories. “Outside the premises” refers to, for example, areas such as ordinary roads. In other words, even for the same event, the commands vary depending on whether it occurs within the premises such as factories, or outside the premises. In this way, by properly using different rule sets according to the location, it is possible to determine whether appropriate safety confirmations and the like are made according to the location.

In FIG. 4, regarding the event of starting inside the premises, the time range of video data to be clipped is 30 seconds before starting. In the event of starting (advancing), it is indicated as a confirmation operation to determine whether the forward pointing and calling “cleared for departure” are performed.

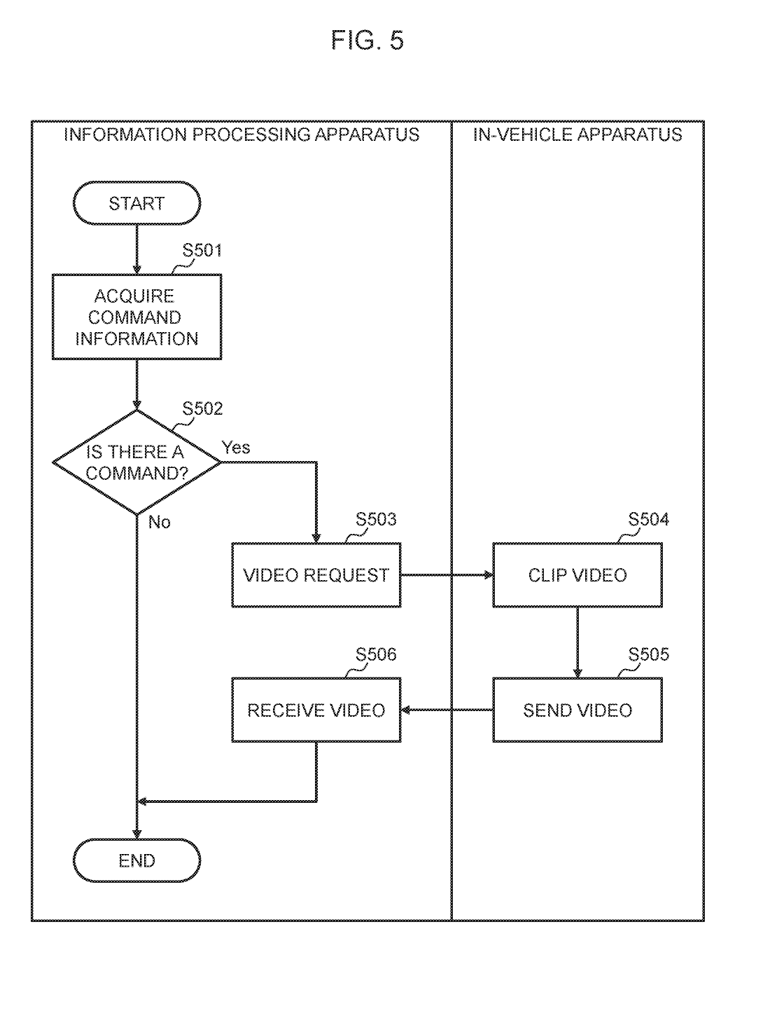

FIG. 5 is a more detailed explanation of step S203 in FIG. 2. In step S501, command information is acquired from the event information 158 in FIG. 1. Next, in step S502, the acquisition status of the command information is confirmed. If there is an command, the processing proceeds to step S503; if not, the processing is ended. In step S503, the processing of requesting the in-vehicle apparatus for the video corresponding to the current time of the acquired command and the determination time is executed, and the processing proceeds to step S504. In step S504, the in-vehicle apparatus that has received the request acquires the video for the specified time from the image information 373 in FIG. 1. In step S505, the acquired video is sent to the information processing apparatus 10. In step S506, the information processing apparatus receives the video and saves the video in the image information 156 in FIG. 1, and then the processing is ended.

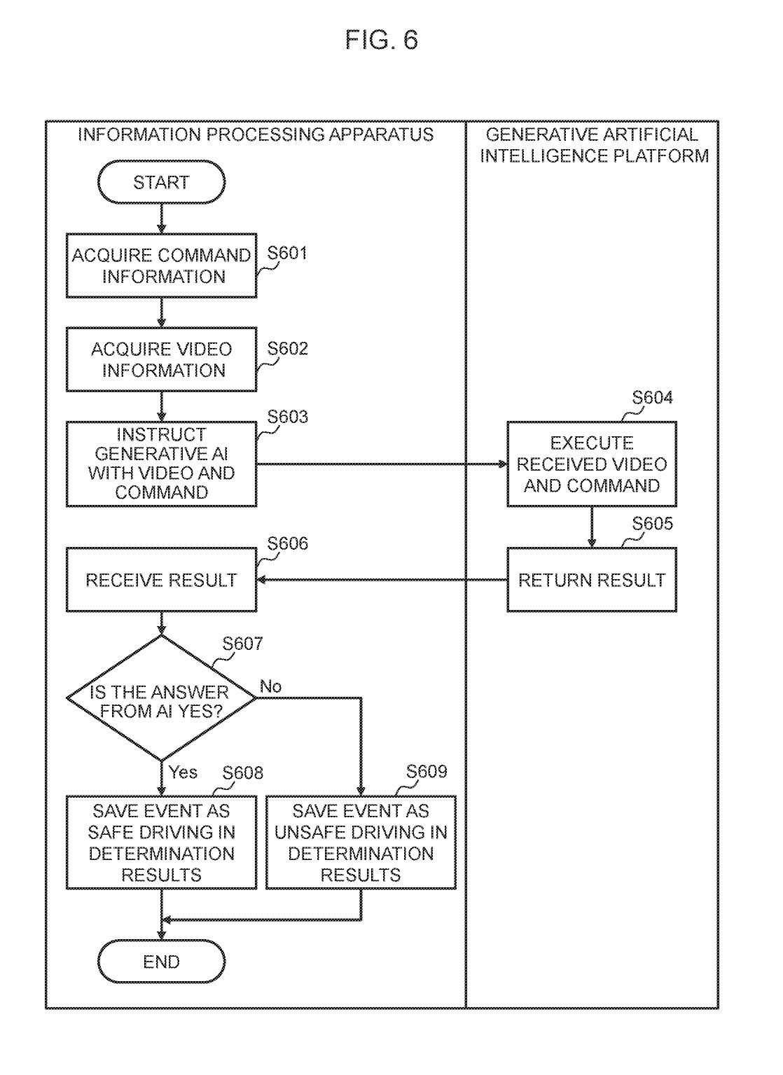

FIG. 6 is a more detailed explanation of step S104 in FIG. 2. In step S601, command information is acquired from the event information 158 in FIG. 1. Next, in step S602, video information is acquired from the image information 156 in FIG. 1. In the next step S603, the generative artificial intelligence platform 20 is instructed with the command text of the acquired command information and the processing of the video information. In step S604, the generative artificial intelligence platform 20 executes the processing of the video information on the basis of the received command text. In step S605, the generative artificial intelligence platform 20 returns the execution result. In step S606, the information processing apparatus 10 receives the result. In step S607, the answer from the artificial intelligence is determined. If it is Yes, the processing proceeds to step S608; if it is No, the processing proceeds to step S609. In step S608, the target event is regarded as safe driving, the occurrence time and the employee information are combined and saved in the determination result information 152 shown in FIG. 1 as the determination result table shown in FIG. 12, and then the processing is ended. In step S609, the target event is regarded as unsafe driving, and the file path of the video information of the event stored in the image information 156 in FIG. 1, and the occurrence time and the employee information are combined and saved in the determination result information 152 shown in FIG. 1 as the determination result table shown in FIG. 12, and then the processing is ended.

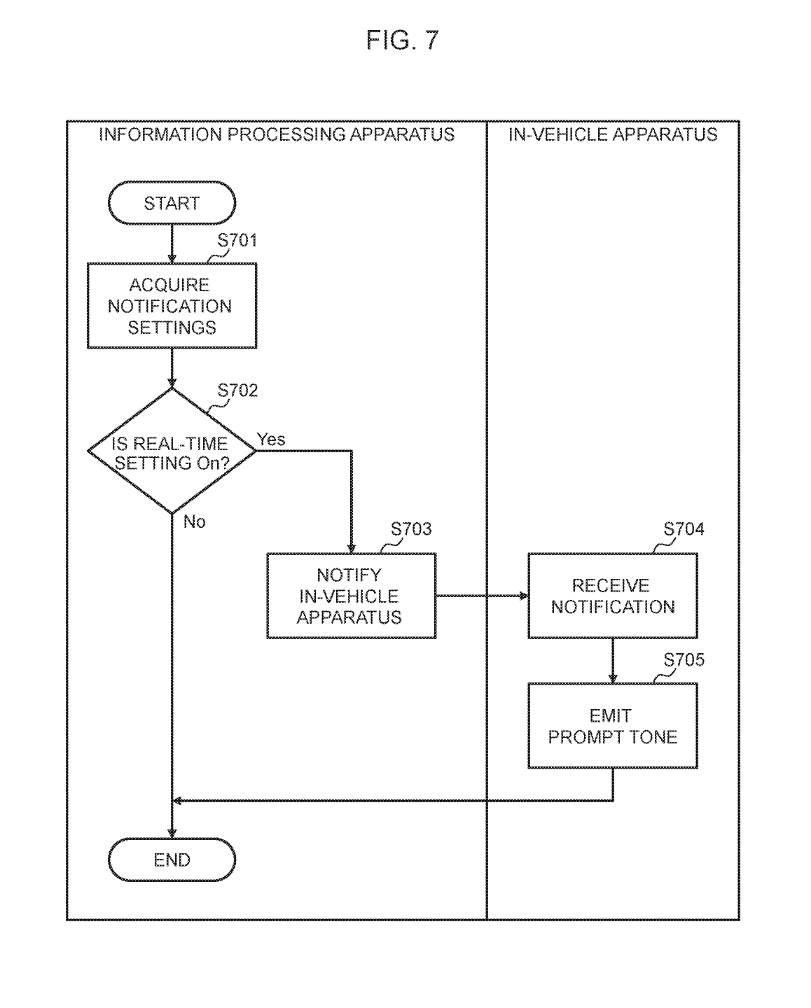

FIG. 7 is a more detailed explanation of step S105 in FIG. 2. In step S701, the information processing apparatus 10 acquires real-time notification setting from the notification setting information 154 in FIG. 1. In step S702, if the acquired real-time notification setting is On, the processing proceeds to step S703; if it is Off, the processing is ended. In step S703, a notification is sent to the in-vehicle apparatus 31. In step S704, the in-vehicle apparatus 31 receives the notification. In step S705, the in-vehicle apparatus 31 uses the speaker 36 in FIG. 1 to emit a prompt tone so as to warn the driver, and then the processing is ended.

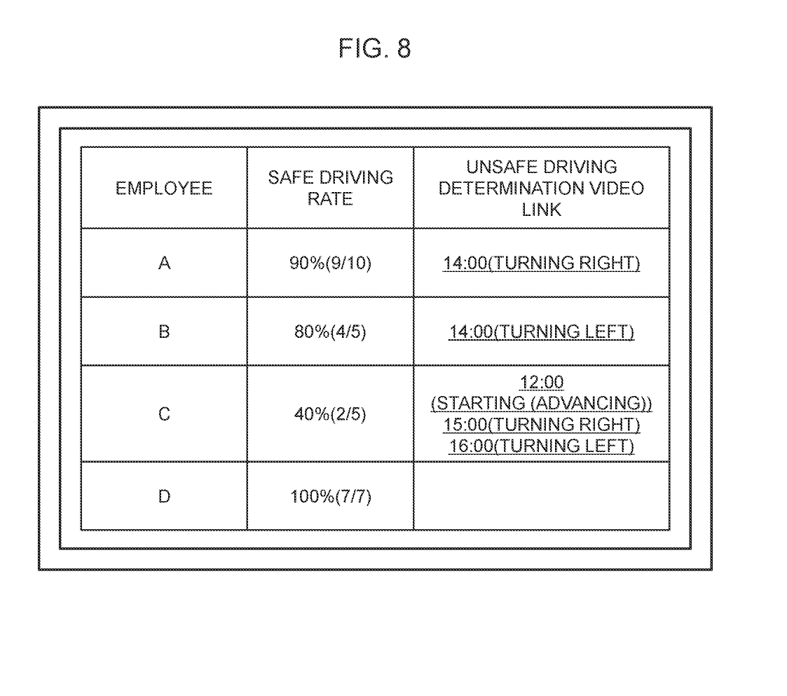

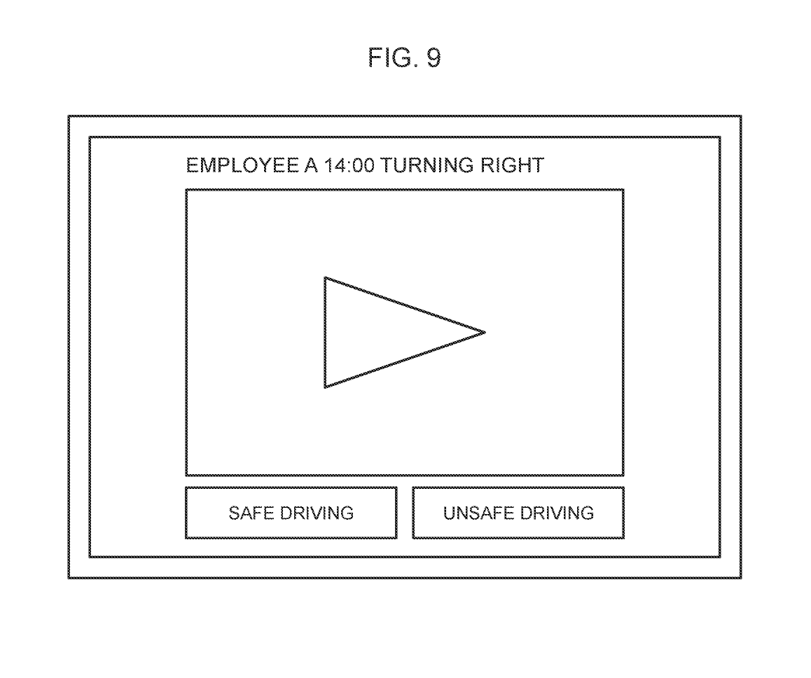

FIG. 8 is a screen image displayed when an administrator checks a management screen. The information processing apparatus 10 acquires a employee list from the master information 153 in FIG. 1 on the basis of the operation of the administrator and displays same in the first column. In the second column, the rate (with the number of safe driving times as the numerator and the total number of events as the denominator) based on the determination results acquired from the determination result information 152 in FIG. 1 is displayed. In the third column, the file paths of the videos determined as unsafe driving are displayed. Clicking on a file path of a video jumps to the playback screen shown in FIG. 9, where the content of the video can be confirmed. The administrator can confirm the content of the video and re-determine whether it is safe driving or unsafe driving. If safe driving is selected, the selected target event should be updated to safe driving, requiring an update to the determination result information 152 in FIG. 1 and a refresh of the screen in FIG. 8. It should be noted that FIG. 8 is one example of a display method, and it is also possible to represent data related to organizations instead of employees.

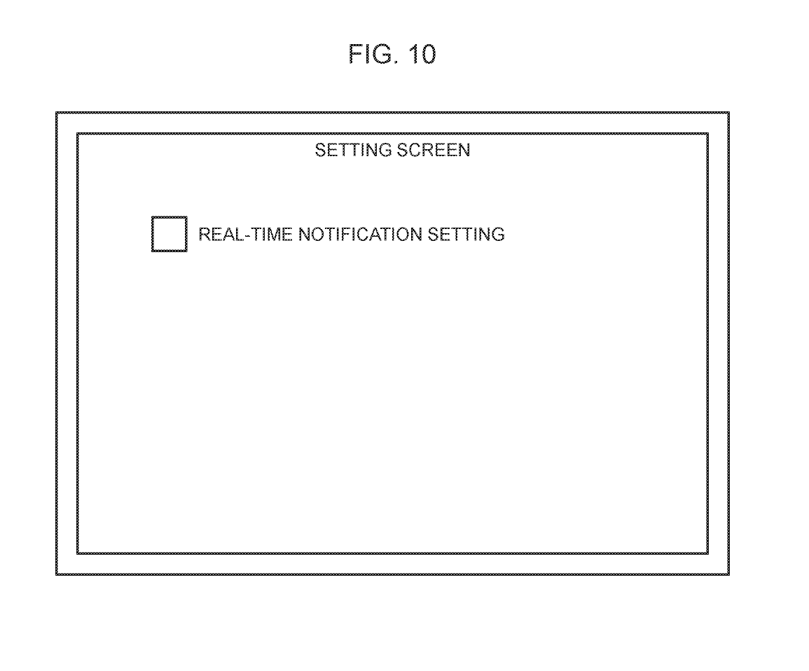

FIG. 10 is a screen where the administrator configures a real-time notification setting. By turning on the real-time notification setting check box, real-time notifications are enabled.

Using the mechanism mentioned above, it is possible to solve the problem.

As described above, the information processing apparatus 10 is an information processing apparatus for determining the presence or absence of safe driving behavior of a driver on the basis of video data, which includes: a communication portion (interface apparatus 16) that communicates with a vehicle and/or a terminal on the vehicle; and a processing portion (processor 11) that processes data, wherein the communication portion receives mobile body information including information about the speed and location of the vehicle; the processing portion detects an event related to the movement of the vehicle from the mobile body information; the communication portion receives video data including driving operations of the driver corresponding to the event; the processing portion identifies a condition corresponding to the event; and the processing portion obtains a determination result by using the condition and the video data as inputs to a determination portion.

According to this configuration and operation, it is possible to reduce the burden on an administrator to confirm a driver's compliance state with safe driving while limiting the communication volume of videos from an in-vehicle terminal to the bare minimum.

In addition, the terminal on the vehicle continuously captures and accumulates video data in which the driver enters a capturing range; the processing portion determines the time range of the video data to be requested from the terminal on the vehicle according to the event; and the communication portion transmits a request for provision of the video data by specifying the time range.

According to this configuration and operation, the size of video data can be changed according to the event, so that the communication volume can be efficiently reduced.

In addition, the mobile body information includes information about the acceleration of the vehicle and location information of the vehicle; and the terminal on the vehicle is an in-vehicle terminal mounted on the vehicle or a portable terminal that can be installed in the vehicle.

In other words, information about the vehicle can be acquired from any terminal, and it may also be the vehicle itself.

In addition, the event includes any of starting, turning right or left, and passing through an intersection by the vehicle; the condition includes text indicating a confirmation operation that the driver should perform corresponding to the event; and the determination portion is a generative artificial intelligence platform that determines, by using the text and the video data as inputs, whether the driver has performed the confirmation operation.

According to this configuration and operation, by issuing commands to the generative AI on a text-based basis, it is possible to determine whether the driver has performed the confirmation operation, thereby improving operability.

In addition, the communication portion transmits the condition and the video data to an external apparatus having the determination portion, and receives the determination result from the external apparatus.

With this configuration, the effect of reducing communication volume can also be achieved with an external apparatus having a determination portion.

In addition, the processing portion switches, according to the location of the vehicle, a rule set indicating the correspondence between the event and the condition.

According to this configuration and operation, safe driving behaviors can be appropriately set for each location, and it can be determined whether the driver is performing safe driving behavior.

In addition, the processing portion aggregates and outputs the event and the determination result for each driver.

According to this configuration and operation, safe driving behaviors of a plurality of drivers can be comprehensively managed.

In addition, the communication portion receives the mobile body information in real time, transmits the determination result on the basis of the mobile body information, and notifies the driver.

According to this configuration and operation, any oversights in safety confirmation can be notified to the driver in real time, so that compliance with safe driving can be ensured.

It should be noted that the invention is not limited to the above-described embodiments, and includes various modifications. For example, the embodiments described above have been described in detail for easy understanding of the invention, and the invention is not necessarily limited to those including all of the configurations described above. In addition, the configuration is not limited to being deleted, and the configuration may be replaced or added.

For example, events and safe driving behaviors are not limited to the examples in the above-mentioned embodiments and can be set arbitrarily.

What is claimed is:

1. An information processing apparatus for determining the presence or absence of safe driving behavior of a driver on the basis of video data, the information processing apparatus comprising:
a communication portion that communicates with a vehicle and/or a terminal on the vehicle; and
a processing portion that processes data, wherein
the communication portion receives mobile body information including information about the speed and location of the vehicle;
the processing portion detects an event related to the movement of the vehicle from the mobile body information;
the communication portion receives video data including driving operations of the driver corresponding to the event;
the processing portion identifies a condition corresponding to the event; and
the processing portion obtains a determination result by using the condition and the video data as inputs to a determination portion.

2. The information processing apparatus according to claim 1, wherein
the terminal on the vehicle continuously captures and accumulates video data in which the driver enters a capturing range;
the processing portion determines a time range of the video data to be requested from the terminal on the vehicle according to the event; and
the communication portion transmits a request for provision of the video data by specifying the time range.

3. The information processing apparatus according to claim 1, wherein
the mobile body information includes information about the acceleration of the vehicle and location information of the vehicle; and
the terminal on the vehicle is an in-vehicle terminal mounted on the vehicle or a portable terminal that can be installed in the vehicle.

4. The information processing apparatus according to claim 1, wherein
the event includes any of starting, turning right or left, and passing through an intersection by the vehicle;
the condition includes text indicating a confirmation operation that the driver should perform corresponding to the event; and
the determination portion is a generative artificial intelligence platform that determines, by using the text and the video data as inputs, whether the driver has performed the confirmation operation.

5. The information processing apparatus according to claim 1, wherein
the communication portion transmits the condition and the video data to an external apparatus having the determination portion, and receives the determination result from the external apparatus.

6. The information processing apparatus according to claim 1, wherein
the processing portion switches, according to the location of the vehicle, a rule set indicating the correspondence between the event and the condition.

7. The information processing apparatus according to claim 1, wherein
the processing portion aggregates and outputs the event and the determination result for each driver.

8. The information processing apparatus according to claim 1, wherein
the communication portion receives the mobile body information in real time, transmits the determination result on the basis of the mobile body information, and notifies the driver.

9. An information processing method for determining the presence or absence of safe driving behavior of a driver on the basis of video data, the information processing method comprising the steps of:
an information processing apparatus receiving, from a vehicle and/or a terminal on the vehicle, mobile body information including information about the speed and location of the vehicle;
the information processing apparatus detecting an event related to the movement of the vehicle from the mobile body information;
the information processing apparatus receiving video data including driving operations of a driver corresponding to the event;
the information processing apparatus identifying a condition corresponding to the event; and
the information processing apparatus obtaining a determination result by using the condition and the video data as inputs to a determination portion.
